(19) United States
(12) Patent Application Publication
(10) Pub. No.: US 2002/0187020 A1
(43) Pub. Date: Dec. 12, 2002

(54) Nitinol washers

(76) Inventor: Gerald J. Julien, Puyallup, WA (US)

Correspondence Address: J. Michael Neary, Neary Law Office, 542 SW 298th Street, Federal Way, WA, 98023, US

(21) Appl. No.: 10/167,799

(22) Filed: Jun. 11, 2002

Related U.S. Application Data
(60) Provisional application No. 60/297,492, filed on Jun. 11, 2001.

(51) Int. Cl. F16B 43/02

(52) U.S. Cl. 411/544

(57) ABSTRACT

A lock washer for locking a threaded fastener from loosening under vibration includes an annular body with a central opening cutting from a sheet or plate of Nitinol, and an integral layer of NiTiOx on at least one face of said body. The lock washer is made of a high transition temperature form of Type 55 Nitinol that remains in its martensitic state in all normal conditions of use. The martensitic Nitinol initially yields during torquing of the nut to allow the nut to indent itself slightly into the lock washer. The resulting cold working of the washer material causes a transformation into stress-induced martensite, which is strong and elastic to resist further deformation and also exerts a preload on the bolt shank. The nut, indented into the lock washer, strongly resists turning under vibration, which effect is further enhanced by the vibration absorbing characteristics of the material. The integral layer of NiTiOx on the surface of the washer provides electrical insulation, minimizing galvanic corrosion.

This is related to U.S. Provisional Application No. 60/297,492 filed on Jun. 11, 2001 and entitled “Nitinol Washers”. This invention pertains to washers, and more particularly to Nitinol washers that provide vibration damping, sealing against leakage under a bolt head or nut, superior resistance to loosening of threaded fasteners under extreme vibration, and an adjustable tensile preload on a bolt or other load.

### BACKGROUND OF THE INVENTION

A longstanding problem with threaded fasteners, for as long as they have existed, is loosening under vibration. Because of the nature of the thread on a screw, which is essentially a helical wedge, vibration tends to cause the screw to back out of a tapped hole, or cause a nut to back off of a threaded shank. When a threaded fastener becomes loosened, it can continue to unthread itself under vibration and actually fall out of the fastener hole. Even if it remains in the fastener hole and continues holding the parts together, it loses its tensile preload and becomes far more susceptible to early fatigue failure. These are serious problems and have been the subject of many efforts to solve them.

One anti-loosening technique is a lock nut having a portion of the bore that is an upset or non-cylindrical, such as an oval bore or one that is peened or staked on one side. The non-cylindrical bore portion produces regions of thread that have an interference fit with the threaded shank of the bolt to resist loosening under vibration or other influences. This approach can work well if it is done properly, but often produces damage to the bolt or to the nut such that they cannot be reused with any certainty that they will lock properly.

Lock washers of various types have been used to minimize loosening. One type uses one-way grippers that slide in one direction (the tightening direction) but have teeth or the like that dig into the part and the face of the nut to prevent turning in the loosening direction. Another type of lock washer, typified by the common split lock washer, is intended to exert a constant preload on the bolt to minimize the tendency of the nut to back off during vibration. Both of these lock washer types are unreliable because of the nature of the steels of which they are made, which creep or take a set after time under load.

Another less common technique to minimize loosening of nuts and bolts under vibration is the lock nut that is tightened over the main nut and torqued against it to put the bolt shank and threads under tension The purpose is to strain the bolt shank enough that it will resist loosening under vibration, but the use of a secondary lock nut like this tends to defeat one of the purposes of preloading the bolt, namely to minimize fatigue failure in the bolt. Secondary lock nuts of this type are primarily of use with parts made of material or configuration which cannot tolerate a heavy preload.

The problem is especially severe in some applications, particularly in aerospace, where the prospect of losing a fastener because of vibration can be catastrophic. One solution used in such applications is to drill a hole through the shank of the bolt behind the position which the nut will occupy and, after assembling the parts and tightening the nut on the bolt, inserting a lock wire through the hole. The lock wire is twisted or crimped to secure it in place and prevents the nut from backing completely off the bolt shank. This technique effectively prevents the nut from backing completely off the bolt shank, but does nothing to prevent loosening or loss of fastener preload.

There are numerous applications in which a sealing washer would be useful. A sealing washer is one which establishes a fluid seal with the structural component under the bolt head. Sealing washers would be useful in bulkheads, hatch covers, fuel tanks and other such applications which now use welded studs or the like. Stud welding is an effective technique for creating a threaded attachment to a structural component without the need for a fastener hole, but there are benefits to the use of conventional fasteners, such as superior strength, lower cost, ease of repair and maintenance, and usability on virtually all structural materials. At present, the only sealing washers available are elastomers and soft metal such as copper and lead. The elastomers are unable to tolerate high temperatures or high tensile preloads on the fastener. Soft metal washers are prone to flatten and become thinner under load, causing a relaxation of the fastener preload and loss of the interfacial pressure necessary for sealing, and they are susceptible to galvanic corrosion as well as attack by many common corrosive agents.

Thus, a need has long existed for a simple, effective washer that can be used with a large variety of fasteners, is reusable, and is highly effective to maintain the fastener preload and resist loosening of the fastener under vibration. Ideally, such a new washer would also absorb vibration energy and convert it from mechanical or kinetic energy to heat. This new washer could also perform as a high temperature, corrosion resistant, high pressure seal for sealing around the fastener to prevent fluid leakage through the fastener hole. Finally, such an ideal lock washer would have an electrically non-conductive surface treatment that would minimize galvanic corrosion, and it would be inexpensive, light weight, corrosion-proof, and extremely durable and long lasting.

### DESCRIPTION OF THE DRAWINGS

The invention and its many attendant benefits and advantages will become better understood upon reading the following detailed description of the preferred embodiments in conjunction with the following drawings, wherein:

FIG. 1 is an elevation of a bolt loosely installed in a fastener hole through two structural members to be fastened together, with a washer in accordance with this invention under the nut;

FIG. 2 is an elevation of the parts shown in FIG. 1, with the nut torqued down and indented into the washer;

FIG. 3 is an enlarged sectional elevation of the circled portion of FIG. 2, showing the indentation of the nut into the washer;

FIG. 4 is a plan view of the washer along lines 4-4 in FIG. 2, at the bottom face of the nut, showing the indentation of the nut into the washer;

FIG. 5 is a perspective view of a corrugated washer in accordance with this invention, with a portion cut out to shown details of the configuration;

FIG. 6 is a sectional elevation of a stack of corrugated washers, like the washer shown in FIG. 5, between a nut and two structural members in a fastened assembly before torquing;

FIG. 7 is a perspective view of a composite corrugated washer of the type shown in FIG. 5, but having two layers of different types of Nitinol bonded together;

FIG. 8 is a sectional elevation of a fastened assembly similar to that shown in FIG. 6, using a stack of two washers shown in FIG. 7, showing the washers partially flattened under tensile load exerted by torquing the nut;

FIG. 9 is a sectional elevation of a stack of Belleville washers in accordance with this invention, in an assembly before torquing to compress the stack;

FIG. 10 is a sectional elevations of a Nitinol refrigeration unit in accordance with this invention, using a stack of Nitinol Belleville washers in accordance with this invention; and

FIGS. 12 and 13 are sectional elevations of a projectile launcher in accordance with the invention, using a stack of Belleville washers as the propelling force.

### DESCRIPTION OF THE PREFERRED EMBODIMENTS

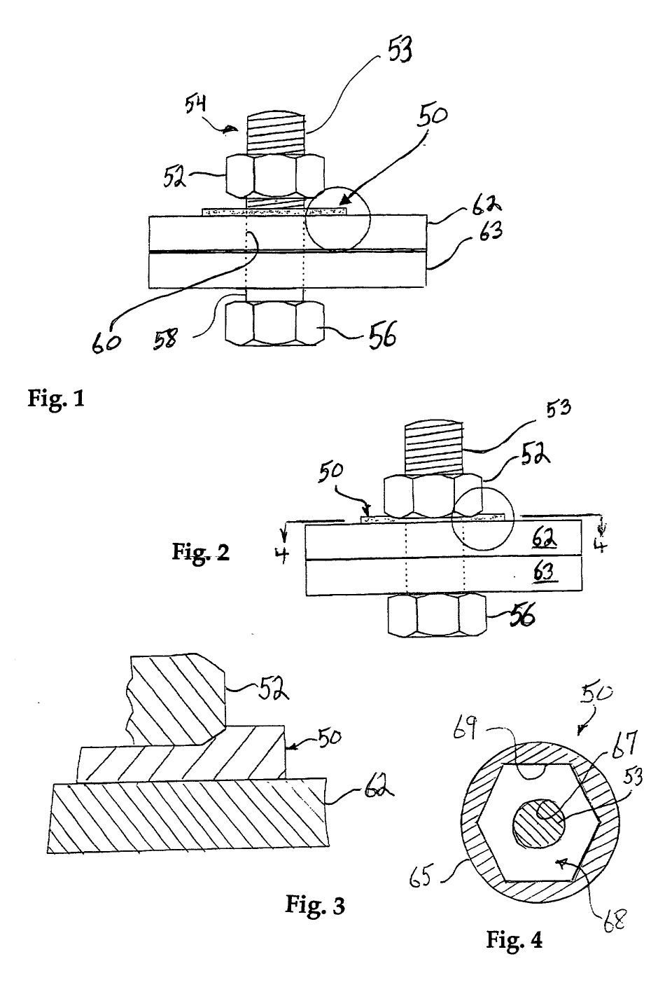

Turning now to the drawings, and more particularly to FIG. 1 thereof, a washer 50 is shown under a nut 52 threaded onto a threaded end 53 of a bolt 54. The bolt 54 has a head 56 on one end of a shank 58, which is at least partially threaded along a region at its distal threaded end 53 to threadedly engage the nut 52. The bolt shank 58 extends through two aligned fastener holes 60 in structural parts 62 and 63 to be fastened together with the bolt 54 and nut 52.

The washer 50 has an annular body 65 having a central hole 67 that receives the bolt shank 58. The annular body 65 is normally circular in plan view so that the pressure exerted at the outer periphery of the annular body is uniform, but the annular body could also be made in other shapes such as square and oval, etc., to accommodate the particular dimension and fit requirements of the particular application. A flat edge or a notch may be provided to accommodate a vertical edge or corner of another structure adjacent to a bolt hole, or straight opposing edges may be provided to allow the washer to fit into a groove or recess to ensure that the washer does not rotate while the nut is being torqued.

The washer 50 performs several functions: it exerts a continuous preload on the bolt after it has been torqued to the preload specified for that particular application; it provides an anti-turning or back-off resistance to the nut 52, and it provides a seal between the nut and the adjacent structural member 62. These distinct functions of this unique lock washer are found only separately in prior art lock washers. These functions are attained by the use of the specific material of which the lock washer is made and the configuration, all as described in detail below.

The washer 50 is made of Nitinol, preferably a high transition temperature form of Type 55 Nitinol that remains in its martensitic state in all normal conditions of use. In the martensitic state, Type 55 Nitinol has a relatively low yield strength of about 15 KSI, and has a very high specific damping capacity of about 40%. When subjected to cold work, Type 55 martensitic Nitinol is transformed to stress-induced martensite, in which state it has a high yield strength and becomes highly elastic. This combination of characteristics make Type 55 Nitinol an excellent lock washer material because it initially yields during torquing of the nut to allow the nut to indent itself slightly into the washer 50, which then becomes strong and elastic to resist further deformation and also exerts a preload on the bolt shank. The nut, indented into the lock washer, strongly resists turning under vibration, which effect is further enhanced by the vibration absorbing.

Two examples of the washers described above illustrate the locking characteristic of washers according to this invention. Two washers of identical outside diameter (0.835″) and hole diameter (0.505″), but of two different thicknesses (0.072″ and 0.120″), were made and tested. Both washers were martensitic high transition temperature Type 55 Nitinol, made by a process described below. Each washer 50 was placed on a bolt shank 58 of a ½″ bolt 54 between a nut 52 and a structural member 62, as shown in FIGS. 1 and 2, and tightened to 100 ft-lbs with a torque wrench and then loosened with a torque wrench to measure the amount of torque needed to release the nut. For the 0.072″ thick Nitinol washer, the release torque was 82 ft-lb torque, and for the 0.120″ thick Nitinol washer, the release torque was 92 ft-lbs. This compares with a release torque of 28-32 ft-lbs for a comparable sized standard SAE split steel lock washer torqued to the same tightening torque.

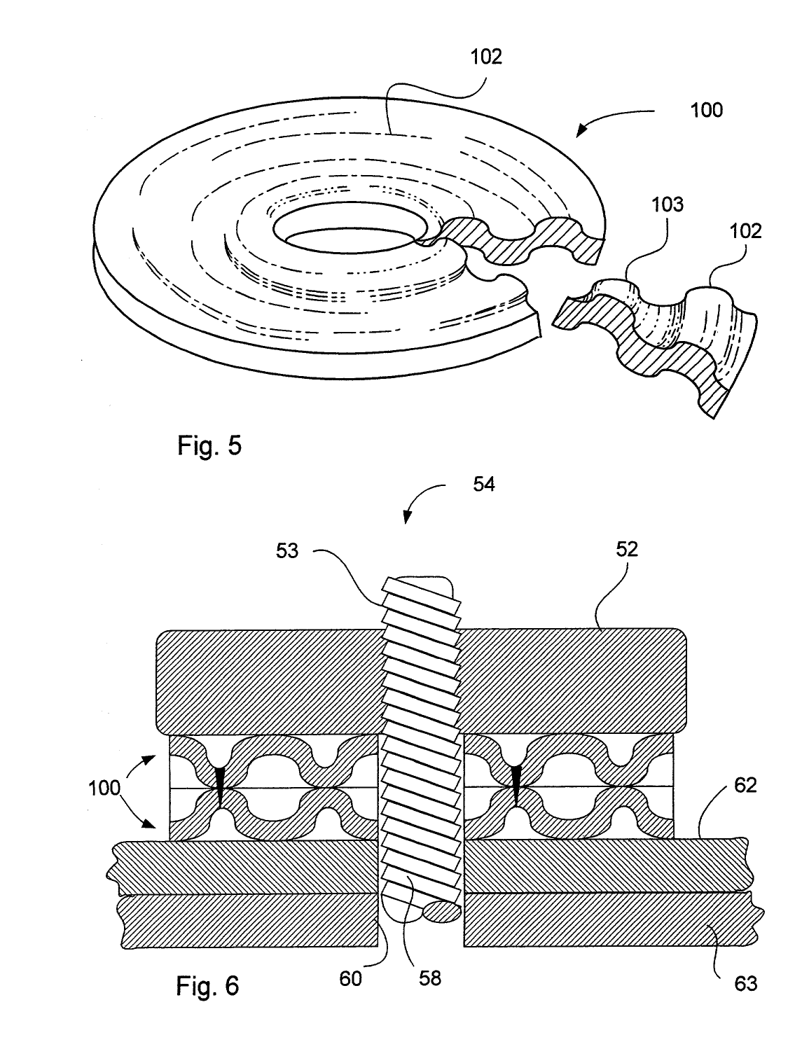

This superior static holding strength of the Nitinol washers 50 is believed to be a result of the elastic strain of the Nitinol, together with its ability to yield and allow the nut to indent itself slightly into the surface of the washer. After a small degree of plastic strain, the martensitic Nitinol transforms to stress-induced martensite, which has increasing yield strength and is highly elastic. The elastic strain exerts a resilient reaction force against the nut, maintaining preload and resisting rotation of the nut during vibration. As shown in FIG. 3 and most clearly in FIG. 4, the indentation of the nut 52 into the surface of the washer body 65 creates a hex-shaped recess 68 in the surface of the washer body 65 having edges or shoulders 69 corresponding to the six flat faces of the nut. The edges or shoulders 69 of the recess 68 are created as the Nitinol recovers elastically after the points or corners of the nut pass while the nut is torqued down against the washer 50. The hexagonal recess 68 tends to lock the nut 52 in place against turning.

The martensitic 55 Nitinol has a specific damping capacity of about 40%, which provides the washer 50 with the ability to absorb large amounts of energy and convert it to heat. Vibration damping is a very useful function in machine and component mounting because it isolates the component from vibration in the machine, or visa versa. It is also especially effective under the nut and/or head of a bolt for reducing the tendency of the nut or bolt to back off the threads on which it is threadedly engaged because the vibrations are absorbed instead of transmitted to the nut or bolt. It is the relative movement of the nut or bolt during vibration with respect to the thing it is threaded onto or into that is believed to cause the backing off, so absorbing a large proportion of this vibration reduces the tendency of the nut or bolt to back off during vibration.

The washer 50 shown in FIGS. 1-3 is made from a rolled sheet of high transition temperature form of Type 55 Nitinol in its martensitic state. The sheet is rolled to the desired thickness, described below, and requires no special processing before cutting. The material is available from Oremet Wah Chang in Albany, Oreg. As delivered from the supplier, the rolled material is in a monolithic condition, that is, it is not sintered, contains no voids, and is uniform throughout. The transition temperature is determined by the composition, and varies according to the ration of nickel and titanium. At a 50/50% atomic ratio, the transition temperature is about 80° C., so it stays in its martensitic state for all normal industrial applications. It the temperature increases above the transition temperature of the material, it will spontaneously transform to austenite and attempt to recover to its prestrained shape and size. This transformation will have little effect on the function of the washer, other than actually increase the tensile preload on the fastener, as described below.

The washers are cut out of the sheet of Nitinol, preferably by an abrasive waterjet cutting machine, widely available from several sources. The cutting could also be done by an industrial cutting laser, although it is a slightly more costly process, can leave a narrow heat affected zone along the edges of the cut, and leaves a flash around the edges of the cut if not adjusted properly. One such industrial cutting laser is a model 2030 made by Trumph Manufacturing Company which delivers 2600 watts at the cutting point. A high pressure inert gas jet is directed at the cutting point to blow molten material out of the kerf melted by the laser beam. When cutting Type 55 Nitinol plate about 3/16 thick, a cutting speed of about 100 inches/minute or more can be maintained. The washer holes are cut out first, then the washers themselves are cut out from the sheet. For convenience, a small tab may be left connecting the washers to the sheet, small enough to be easily broken by hand, to facilitate handling. The tab may be ground off by hand or the washers may be mounted on a mandrel and edge ground in bulk.

After cutting the washer bodies 65 from the sheet of Nitinol the washers are processed to have an integral surface of hard, electrically non-conductive material to minimize galvanic action which occurs between some dissimilar materials in the presence of an electrolyte such as salt water. The surface material is believed to a complex oxide and is referred to herein as “NiTiOx”. The surface material is created by heating the washers in an oxygen-containing atmosphere, such as air, to a temperature of about 800° C. and immediately quenching them in water or cooling quickly in cold air. The surface material is not a coating that can be peeled or scraped off the washers; it is integral with the parent material since it is actually a reaction product of the surface portion of the parent material. It is very hard, on the order of about 80 RC, and an electrical insulator. By establishing electrical insulation between the Nitinol of the washer 100 and the structural member, galvanic corrosion is reduced or eliminated.

A second embodiment of a washer according to this invention is a corrugated or wave washer 100, shown in FIG. 5. The washer 100 is formed into one or more annular concentric corrugations 102, 103 by a process described below. In FIG. 5, a section has been cut and exploded out of the washer 100, as an illustrative device, to show clearly the corrugations 102 and 103. As used, the washer is an intact complete annulus and no such section is removed from the washer as it is actually used. This washer 100 can be used alone or in stacks or two or more, as shown in FIG. 6. As illustrated in FIG. 6, the washers 100 in the stack may be welded or bonded together to prevent them from slipping laterally with respect to each other and partially nesting, although this may not be needed if they fit closely on the bolt or if partial nesting does not cause a problem. This washer 100 or washer stack is used primarily to provide a preload on the fastener with a greater stroke that the washer 50.

The washers 100 are made of either one of two types of Nitinol: superelastic Type 55 Nitinol or ultraelastic Type 60 Nitinol. “Superelastic” Nitinol is a low transition temperature form of Type 55 Nitinol in the Austenitic state, which has been cold-worked. Superelastic Nitinol has the characteristic of damping shock and vibration, although more springback does occur with the superelastic Nitinol than with the high transition temperature Type 55 Nitinol in its martensitic state. Washers made from superelastic Type 55 Nitinol provide large elastic stroke displacements while attenuating the input force. Wave spring washers 100 made from high transition temperature superelastic form of Type 55 Nitinol provide large stroke displacements while attenuating the input force, and will maintain a preload on the fastener under extreme conditions of vibration and shock. Superelastic Nitinol also has a high damping capacity after it reaches its pseudoelastic range, but it requires a degree of strain before it becomes a good damping material. Superelastic properties (up to about 8-10% strain with full “elastic” recovery) require the imposition of cold work, and those properties can be lost by heating the material.

Superelastic properties are believed to result from a form of Martensite that is stress induced by stress applied in the temperature range above Af(austenite final temperature). Less energy is needed to stress-induce and deform martensite than to deform the austenite by conventional mechanisms. Up to 8% strain can be typically accommodated by this process. Since austenite is the stable phase at this temperature under no-load conditions, the material springs back to its original shape when the stress is removed. This extraordinary elasticity is called “pseudoelasticity” or transformational “superelasticity”. The typical curve of a properly processed Nitinol compound shows the loading and unloading plateaus, recoverable strain available, and the dependence of the loading plateau on the ambient temperature. The loading plateau increases with the ambient temperature. As the material warms above the austenite final temperature, the distinctive superelastic “flag” curve is evident. Upon cooling, the material displays less elasticity and more deformation until it is cooled to where it is fully martensite, thereupon exhibiting the shape memory property and recovering its deformation upon heating. However, Type 55 Nitinol is superelastic in a temperature range of approximately only 50 degrees above the austenite final temperature. Composition, material processing, and ambient temperature greatly effect the superelastic properties of the material. For typical industrial and military applications, the small temperature range of superelasticity of Type 55 Nitinol can be a serious limitation because they often can be expected to operate at temperatures outside that range. Therefore, a second type of Nitinol, denoted “ultraelastic” Type 60 Nitinol, is preferred for making the washer 100.

The interesting properties of pseudoelasticity and shape memory had not been thought to exist in Type 60 Nitinol. Indeed, Type 60 Nitinol has been thought to have no significant elastic properties at all. It has been thought to be too brittle and notch sensitive to serve as an engineering or structural material. However, as disclosed in my pending Patent Application filed on Jun. 11, 2001 and entitled “Manufacturing of Nitinol Parts and Forms”, I have discovered that Type 60 Nitinol can be processed to a form in which it exhibits remarkable elasticity, which I am calling “ultraelasticity” to distinguish it from “superelasticity” of Type 55 Nitinol, and also can be treated to exhibit a shape memory effect. The metallurgical mechanisms that produce ultraelasticity and shape memory effect in Type 60 Nitinol are not fully understood at this time, but the elastic properties and shape memory effect of properly processed Type 60 Nitinol are readily demonstrated in standard objective tests on sample coupons, and also in practical application of the material in applications previously possible only with Type 55 Nitinol.

The properties of ultraelastic Type 60 Nitinol are as follows:

Elastic range: up to about 6%-7% strain.

Temperature range in which ultraelasticity is exhibited: −150° C. to at least about 750° C.

Shape memory effect with a transition temperature of about 85° F.-180° F.

Ultraelastic Type 60 Nitinol also has the following useful properties: hardness that is adjustable from about 22 RC up to about 64 RC, low density, high strength, low modulus, takes a fine surface finish, low CTE, low thermal conductivity, corrosion resistant, and non-magnetic.

The processes for producing ultraelasticity in a Type 60 Nitinol semi-finished form or workpiece include melting Type 60 Nitinol by conventional methods in a vacuum furnace. The type of furnace is not critical but is preferably melted in a draw-down graphite crucible for casting into a billet or ingot of a size that is suitable for hot working. I prefer to use small ingots about 4″-541 square or in cylindrical diameter and about 2′ long for convenience to later casting operations in which the ingots are remelted and cast into parts and forms. The facilities in which those casting operations are done often are limited to ingots of that size. Moreover, I believe a smaller grain size is obtained in the smaller ingots. Alternatively, a larger ingot can be cut or forged into a size that is suitable for hot working, although larger ingots have not worked as well for me in this process. The exact reason for this difference is not entirely clear to me, perhaps because the grain size in a larger ingot tends to be larger than the grain size in a smaller ingot. Smaller ingots intended for rolling can also be cast such as plates 1″-2″ thick, 30″ wide (or whatever the width of the rolling mill is) and 1′-2′ long.

The ingot or workpiece is heated in a heater, such as an oven or furnace or the like, to a working temperature of about 900°C.-950° C. The ingot or workpiece should be held at the working temperature for long enough for the heat to penetrate entirely to its core. I have found that a heating period of at least one hour at that temperature is usually enough for plate of ½-¾″ thick. The heated plate or workpiece is removed and subjected to hot working in a hot working apparatus by rolling, forging or the like to reduce its dimension toward the desired thickness and length. “Hot-working” is defined as straining the workpiece by about 2% and preferably about 25% while holding it at the working temperature. Examples of hot-working include forging, rolling, hot extrusion, and machining.

Preferably, the tools and/or tooling used in the hot-working are insulated or insulating so that their contact with the hot workpiece does not quench its surface region below the working temperature. Pack rolling the Nitinol plate between heated steel sheets is one effective technique to reduce the quenching effect. Tools and tooling made of Type 60 Nitinol are preferred because it is very hard and strong, even at elevated temperatures, and because the low thermal conductivity of Type 60 Nitinol reduces the rate of heat flux out of the workpiece.

It is important that the temperature of the ingot or workpiece not be allowed to drop below about 900° C. while it is being worked because it loses malleability, and cracks can be initiated in the ingot or plate which then must be ground out. Moreover, the strain rate of the hot working should be slow because Type 60 Nitinol is a strain rate sensitive material and impact strains can cause catastrophic shattering of the ingot which could be extremely dangerous for the workers in the vicinity. I have found that I obtain the best results in rolling by limiting the thickness reduction to about 5-15 mils per roller pass, preferably 5-6 mils per roller pass. However, as long as the ingot or plate is maintained at the designated working temperature, greater reductions should be possible.

After the initial hot working, the plate is returned to the furnace and reheated to the working temperature of 900° C.-950° C. for a second pass through the hot working apparatus, such as the rolling mill. After a few rolling and reheating iterations, the plate can be heated to a lower working temperature of 800° C.-900° C., and is allowed to soak at that temperature long enough to completely reheat the plate through to the core. The reheated plate is now re-rolled, at the lower working temperature. Rolling at the lower working temperature proceeds smoothly without breaking or cracking the plate. I am not sure why the later hot working passes can be done at a lower temperature; it may be that the initial hot working reduces the grain size and/or the reheating reduces the presence of hardening precipitates. Whatever the reason, the later hot working passes are smoother than the earlier ones. Rolling is repeated until the plate is elongated and reduced in thickness the desired amount.

The rolled plate produced by this series of heating and rolling steps is very hard and brittle. To obtain the desired ultraelastic properties, the plate is now returned to the furnace and heated to about 700° C.±25° C. and, after reaching equalization throughout, holding at that temperature for for a post-hotwork heat soak period of about 15 minutes to several hours. At the end of the post-hotwork heat soak period, the workpiece is removed from the oven and quenced in a coolant, with agitation to ensure uniform cooling and prevent the formation of an insulating layer of steam or vapor over portions of the part. The heating and post-hotwork heat soak process can be used on rolled plate, extrusions, and cast components.

I believe a metallurgical change occurs during the post-hotwork heat soak. Although the precise nature of that change is not yet clear to me, I believe that the hot working or casting produces hardening precipitates and that the hot soak period dissolves or otherwise removes or reduces those precipitates to give the plate its ultraelastic properties.

The ultraelastic Type 60 Nitinol workpiece may be subjected to an additional heat treatment to a hardness of about 58 RC-64 RC by heating to about 900° C.-950° C., then quenching in water or other coolant such as oil to cool it quickly to a temperature below about 500° C. The coolant should be agitated or the part moved in the coolant bath to ensure a flow of coolant over the surface of the part.

After rapid quenching, the workpiece has a tendency to age harden over a period of several days, producing an increased hardness that may be undesirable. To prevent this age hardening, the workpiece may be heated in boiling water or oven heated to 300° C.-600° C. for several hours and then furnace cooled over several hours or removed and allowed to air cool to room temperature.

The washers may be heat treated to produce a low modulus and relatively low yield strength. I believe this to be a martinsitic state of Type 60 Nitinol. This process includes heating to about 825° C. and holding at that temperature for about an hour, then allowing the part to cool gradually to room temperature over 8-12 hours. Preferably, the part is left in the furnace and the furnace heater elements are simply deenergized. The part is allowed to oven cool slowly, with the doors of the furnace closed to avoid drafts that could cause rapid and/or uneven cooling. The resulting properties include high damping capacity and low yield strength, offering the benefits of the Type 55 martensitic Nitinol discussed above, without the transition temperature limitations.

The process of making the washers 100 includes cutting the washer holes and then cutting washer bodies out of a rolled sheet of superelastic Type 55 Nitinol or ultraelastic Type 60 Nitinol. The cutting can done using abrasive water jet, but is preferably done with the industrial cutting laser noted above. Alternatively, the Type 60 Nitinol can be cast as a thick-walled tube and laser sliced into individual washers, without the need to cut the center hole. The tube could also be sliced using ganged band saws, EDM cutters, or diamond wire cutters, but these processes are normally slower than laser cutting. It would be preferable to perform the heat treating step to achieve ultraelasticity after slicing the tube into individual washers because the cooling of the individual washer would be much faster, so production would be faster. Moreover, the heat treating step in which the surface NiTiOx is formed can be combined with the heat treating step for forming the ultraelastic state of Type 60 Nitinol.

The washer bodies are formed to the corrugated configuration illustrated in FIGS. 5 and 6 by heating them to about 900° C.-950° C. and forming them in a press between two matched dies made of Type 60 Nitinol. The formed washer body is held between the dies until it has cooled to about 500° C. and thereafter retains the formed configuration without any springback. Type 60 Nitinol is used for the tooling because it is very hard and durable and because it has very low thermal conductivity. If the washer body were formed in conventional steel dies, contact with the thermally conductive steel dies would quench the washer body rapidly and cool it below the optimal forming temperature noted. The result could be a cracked part that would suffer fatigue failure quickly in use. The Type 60 Nitinol dies can be made by casting and then heat treating to give them ultraelastic properties and high hardness, or they can be machined from thick rolled slabs or hot forged billets. I believe that hot working improves the properties of Type 60 Nitinol, so tools and parts made from hot-worked Type 60 Nitinol are preferred to tools and parts that are merely cast, without a hot-working step.

In use, the washer 100, or a stack of washers 100, is assembled in a fastened assembly as shown in FIGS. 1 or 6 and the nut 52 is torqued down against the washer or stack of washers 100. The washer(s) 100 flatten under compressive load between the nut and the structural member 62 until they are completely flat. However, even when completely flat, the washer(s) 100 continue to exert a preload on the nut and the attached bolt 54. Because of the 8% elastic strain capability, the washer(s) 100 can recover elastically to the full unstrained condition shown in FIGS. 5 and 6 and exert a preload on the nut for the full stroke of their compression. Moreover, they can be compressed under high tensile load of the bolt 54 indefinitely without taking a set the way steel lock washers are known to do, so the preload is maintained in the most severe environments of vibration. Superelastic Nitinol loses is superelastic properties at elevated temperatures, but ultraelastic Type 60 Nitinol retains its elastic properties at elevated temperatures, even as high as 800° C., so the ultraelastic Type 60 Nitinol would be the preferred material for all high temperature applications.

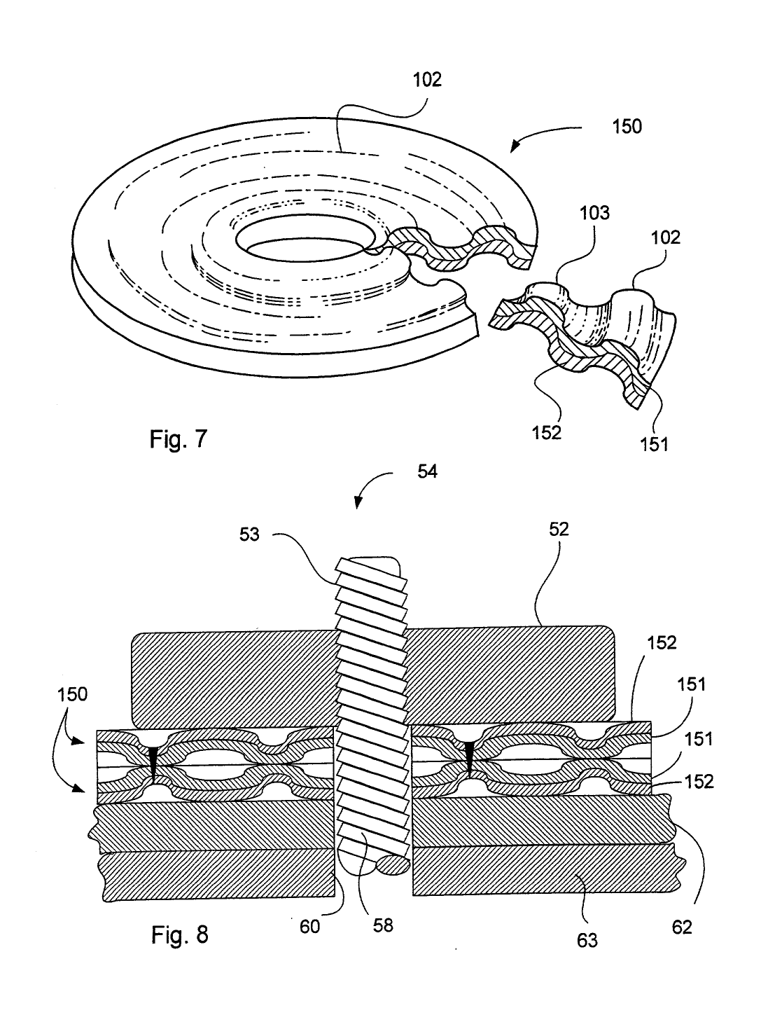

A third embodiment of the invention provides a composite washer 150, shown in FIGS. 7 and 8, having a superelastic Type 55 Nitinol layer or ultraelastic Type 60 layer 151 on the side of the washer 150 adjacent to the structural member 62, and a martensitic layer 152 facing the nut 52. This combination provides an optimal combination of vibration absorption, nut embedding and locking, and strength to provide the desired preload to the fastener 54.

The two layers 151 and 152 of the two different states or types of Nitinol are preferably diffusion bonded. One technique for diffusion bonding dissimilar metals is explosive bonding. A sheet of each of the two different types of Nitinol is thoroughly cleaned and laid with their clean faces in contact, and the sheets are laid on a smooth surface of a strong, solid base such as a 6″ thick slab of steel. A layer of pyrotechnic material is laid over the top of the upper sheet in a manner well know in the art, for example, in the art of making sandwich coins. The pyrotechnic is initiated along one edge and it burns at high speed, creating a pressure wave that causes the two sheets of Nitinol to form a diffusion bond across their entire interface. The impulse must be tailored to provide the force necessary to achieve the diffusion bond, but should not be great enough to cause cracking of the ultraelastic Type 60 Nitinol, which can be strain-rate sensitive.

Another process for forming a diffusion bond between the two sheets of the different types of Nitinol is in a heated press, preferably using a high pressure gas over a thick platen to exert a uniform pressure on the top plate and a flat, strong platen to support the bottom plate. Diffusion bonding of this type is done at about 950° C. and is left under high pressure for several hours or until the diffusion bond forms. Although it is much slower than the explosive bonding and requires expensive press equipment, the potential cost may be less because a large stack of sheets can be bonded in a single batch.

The process for forming the washers 150 is the same as that for forming the washer 100 described above. The diffusing bond is not affected at all by the high temperature or the shear forces exerted during forming because the diffusion bond creates, in effect, a single piece of metal without a distinct junction line between the two layers, but rather a molecular diffusion of the two materials into each other.

In operation, one or more washers 150 are placed, alone or in a stack, in a fastened assembly and the nut 52 is torqued down on the bolt 54 to compress the washer or stack of washers 150. As shown in FIG. 8, the stack of washers has been torqued down about half way to full compression. As shown, the washer grows radially as it is compressed, and the portion that protrudes radially beyond the nut will tend to open axially and engage the edges of the nut beyond the embedding of the nut into the martensitic Nitinol layer 152. As the torquing of the nut proceeds, the washer stack becomes entirely flat under the nut and the nut compresses the martensitic Nitinol layer 152 in contact with the nut, embeding the nut into the martensitic Nitinol layer 152 in the same manner as the washer 50 shown in FIGS. 1-4. The bottom layer of martensitic Nitinol 15 on the bottom washer in the stack shown in FIG. 8 conforms to the microscopic profile of the surface of the structural member 62 an forms a seal with that surface.

This embodiment is more costly that the embodiment shown in FIGS. 1-4 and is used primarily for structural materials such as fiberglass/epoxy and other fiber reinforced plastic materials that cannot tolerate a large magnitude preload but still require a preload and a long stroke elastic preload maintenance device to prevent the loosening of fasteners in the presence of vibration.

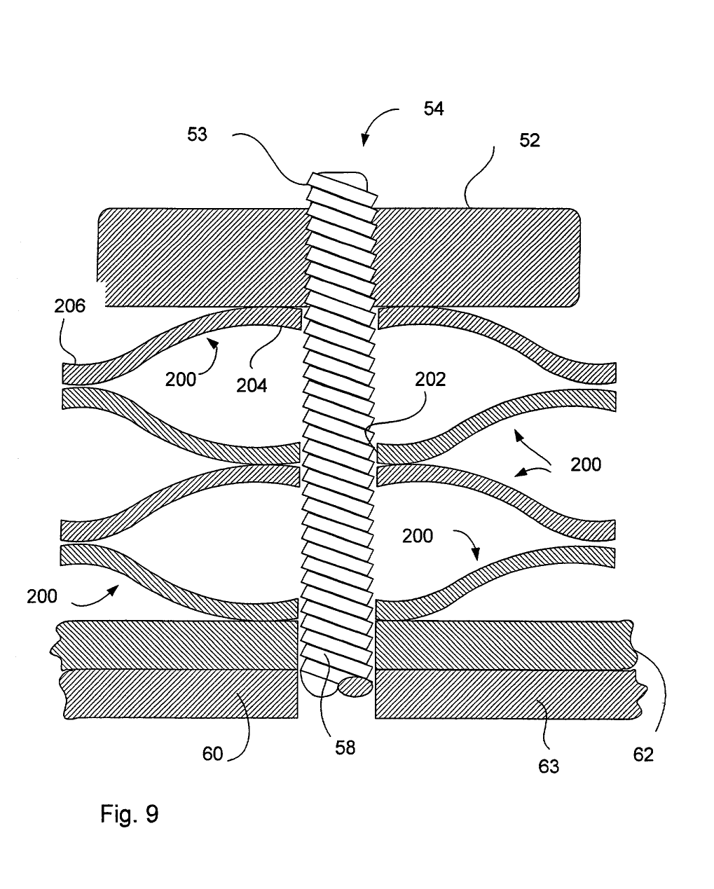

Turning now to FIG. 9, a stack of Belleville washers 200 is shown in an assembly on a bolt 54 or rod. Each Belleville washer is made of Nitinol cut from a rolled plate and formed at high temperature, as described above. The Nitinol is preferably ultraelastic Type 60 because its elastic properties are not temperature sensitive like superelastic Type 55 Nitinol. These Belleville washers could also be bonded two-layer composite structures of ultraelastic Type 60 Nitinol and martensitic Type 55 Nitinol to provide the benefits of elasticity and vibration damping mention above.

The Belleville washers 200 each are dome-shaped with a center axial hole 202 to receive the bolt or rod which maintains their axial alignment. The marginal regions 204 around the hole 202, and the marginal regions 206 around the outside periphery may be flattened slightly to provide a land area to receive and engage corresponding land areas on adjacent Belleville washers to minimize any tendency for adjacent washers to slip sideways when the stack is compressed.

In operation, the Belleville washers 200 are assembled on the bolt or rod in a stack of as many washers needed to provide the stroke required for the application. The nut 52 is tightened to compress the stack to the exert the desired tensile load on the bolt or rod. Forces on the bolt or rod in operation of the stack will allow the stack to compress elastically and exert a restoring axial force on the nut and bolt, even if the stack is compressed completely flat and held in that condition indefinitely. The Nitinol Belleville washers 200 will not take a set and will not corrode in salt water or other corrosive environments for years.

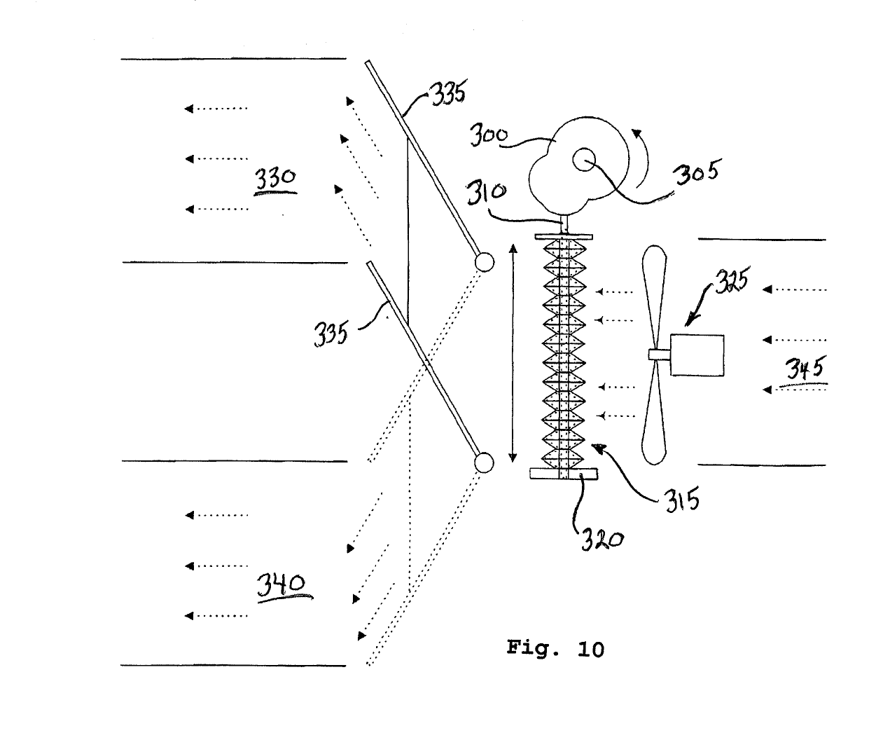

Numerous applications for the stack of Belleville washers shown in FIG. 9 exist, in addition to their use as fastener preload devices. For example, in FIG. 10, a bank of Belleville washer stacks (only one stack of which is shown) can be used as an fluid heater or cooler, acting in effect as a solid state refrigeration system. A series of cams 300 (only one of which is shown) are mounted on a motor driven shaft 305 and bear against the ends of rods 310 which extend down through stacks of Belleville springs 315. The lower end of the rods 310 are guided in holes in a fixed bottom guide plate 320. A bearing disc is attached, as by welding, to the rod 310 above the stack of Belleville springs 315. Operation of the motor (not shown) drives the cams 300 to reciprocated the rods 310 and periodically compress and expand the stack of Belleville springs 315. On the downward stroke, the Belleville springs 315 are compressed and generate heat. Air flow induced by a blower 325 passes around and is heated by conduction from the hot Belleville springs 315 and is deflected into a hot air duct by vanes 335. On the up stroke, the Belleville springs are allowed to relax to their un-strained position and the become cold. The vanes 335 are shifted to lower position, indicated by phantom lines in FIG. 10, and the air flow, now cooled by conduction from the cold Belleville springs 315, is deflected into the cold air duct 340. The hot or cold air, as required, is ducted back through a return air duct for additional heating or cooling to achieve the desired air temperature. The device is also usable for water cooling or heating, using water in a closed system and using a water pump instead of an air blower 325.

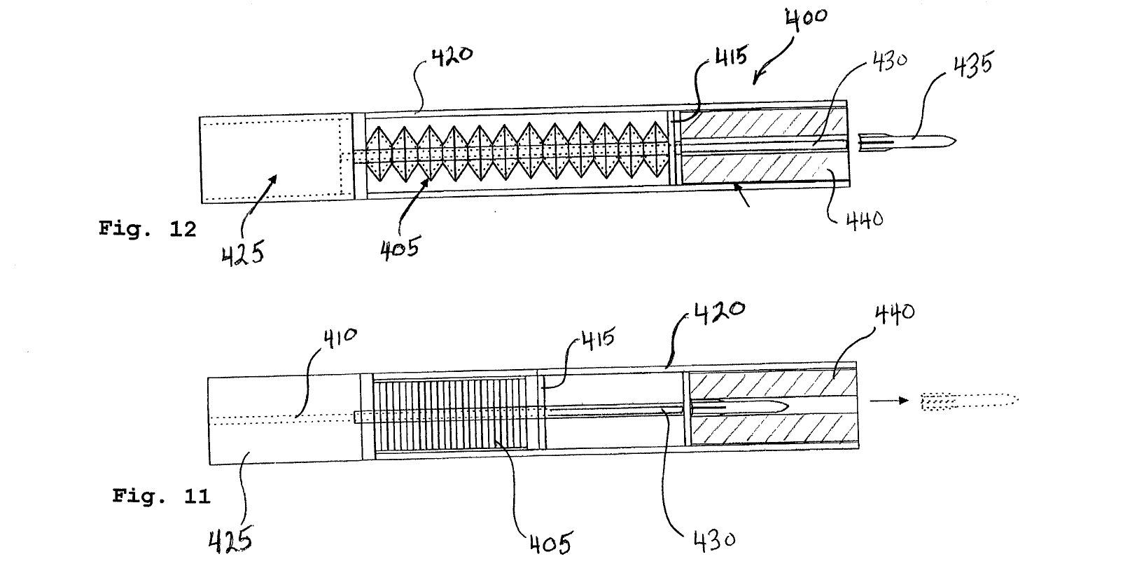

The stack of Belleville springs shown in FIG. 10 can also be used as a source of axial force of substantial stroke. On application of this assembly, shown in FIGS. 11 and 12, is a projectile propelling device 400 having a stack of Belleville springs 405 on a threaded rod 410 and bearing against a front plate 415 guided for straight linear motion in a tube 420. The stack of Belleville springs 405 can be compressed to whatever degree of force is desired by rotating a handle 425 containing a segmented nut (not shown). The stack of Belleville springs 405 is shown fully compressed in FIG. 11.

The stack of Belleville springs 405 can be released by spreading the segmented nut, driving the front plate forward and driving a rod 430 attached to the front plate 415 against a projectile 435, such as a finned bolt shown, or some other form of projectile such as a rubber coated bullet or ball for crowd control. The projectile is mounted in a projectile holder 440 to carry numerous projectiles. The holder could be rotatably mounted on an axis off-set from the axis of the stack of Belleville springs and rotatable to misalign the projectile bore with the rod 430 until the operator is ready to launch a projectile, as a safety measure. Other catch mechanisms could be used in place of the segmented nut, as is know in the projectile launching art, such as cross-bows.

In a larger device, the compression of the stack of Belleville springs 405 could be accomplished by power assist, such as hydraulic or pneumatic actuators. The velocity of the projectile would be moderate, on the order of 1100 fps or higher, depending on the thickness and number of Belleville springs 405 in the stack. The Nitinol springs, either superelastic Type 55 Nitinol or ultraelastic Type 60 Nitinol, would provide a propelling force for the entire length of the stroke. The launch would be silent and without generation of overpressure which is typical when firing a high powered firearm in a confined space, so it would be useful for police action and urban warfare, as well as covert action where silence is important.

Obviously, numerous modifications and variations of the several embodiments described above are possible and will become apparent to those skilled in the art in light of this disclosure. Also, many functions, objects and advantages are described in the preferred embodiments, but in some uses of the invention, not all of these functions, objects and advantages would be needed, desired or attained. Therefore, I contemplate the use of the invention using fewer that the complete set of noted functions and advantages. Moreover, numerous species and embodiments are disclosed herein, but not all are specifically claimed in species claims, although all are covered by generic claims. Nevertheless, it is my intention that each and every one of these species and embodiments, and the equivalents thereof, be encompassed and protected within the scope of the following claims, and no dedication to the public is intended by virtue of the lack of claims specific to any individual species. Accordingly, it is expressly intended that all the disclosed species and embodiments, and the numerous modifications and variations, and the equivalents thereof, are to be considered within the spirit and scope of the invention as defined in the following claims, wherein I claim:

1. A method of making a Nitinol washer, comprising:
selecting a sheet or plate of monolithic hot-worked Nitinol; and
cutting an annular body with a central opening from said sheet.

2. A method as defined in claim 1, wherein:
said cutting is by abrasive waterjet.

3. A method as defined in claim 1, wherein:
said Nitinol sheet is Type 55 Nitinol having a transition temperature above about 100° C. so that it remains in its Martensitic state for all normal conditions of use.

4. A method as defined in claim 1, further comprising:
producing an integral layer of NiTiOx on at least one face of said body by heating said body to an elevated temperature above about 500° C. and then quenching said body.

5. A fastened assembly, comprising:
two juxtaposed parts having an aligned fastener hole therethrough;
a fastener under tension extending through said aligned hole in said two parts, said fastener having a shank extending through said hole and a securement device, such as a nut or a swaged collar, for maintaining a tensile preload on said shank;
an annular Nitinol washer between a protected item and an impacting force;
whereby said impacting force will deform said Nitinol structure and said Nitinol structure will absorb significant portions of the energy in said impacting force by deforming said Nitinol washer.

6. A fastened assembly as defined in claim 5, wherein:
said Nitinol in said annular Nitinol body is monolithic Type 55 Nitinol in its martensitic state.

7. A fastened assembly as defined in claim 5, further comprising:
a hard, abrasion resistant, electrically insulating, integral NiTiOx layer between said annular Nitinol body and said juxtaposed parts.

8. A fastened assembly as defined in claim 5, wherein:
said Nitinol structure is a corrugated washer.

9. A fastened assembly as defined in claim 8, wherein:
said Nitinol structure includes two layers of different types of Nitinol bonded together, said layers including martensitic Type 55 Nitinol and either superelastic Type 55 Nitinol or ultraelastic Type 60 Nitinol.

10. An article, comprising:
an annular disc having a central opening, said annular disc being made of monolithic Nitinol.

11. An article as defined in claim 10, wherein:
said Nitinol is Type 55 Nitinol heat treated to have shape memory characteristics.

12. An article as defined in claim 10, wherein:
said Nitinol is superelastic Type 55 Nitinol; and
said annular disc is dished to form a Belleville spring that exerts an axial restoring forced when flattened axially.

13. An article as defined in claim 10, wherein:
said Nitinol is ultraelastic Type 60 Nitinol; and
said annular disc is dished to form a Belleville spring that exerts an axial restoring forced when flattened axially.

14. An article as defined in claim 10, further comprising:
said annular disc is dished to form a Belleville spring that exerts an axial restoring forced when flattened axially;
said annular disc is one of multiple Belleville springs disposed in alternating orientation to face each other with wide diameters in contact, and small diameters in contact with adjacent Belleville springs; and
a guide rod through a center hole in each of said Belleville spring to maintain said Belleville springs in an aligned stack.

15. An article as defined in claim 14, wherein:
said stack of Belleville springs exerts an axial force on a projectile in a projectile launcher.

16. An article as defined in claim 14, wherein:
said stack of Belleville springs converts mechanical energy to thermal energy in a fluid heat exchanger.

17. An article as defined in claim 14, wherein:
said Nitinol is ultraelastic Type 60 Nitinol.

18. An article as defined in claim 14, wherein:
said Nitinol is superelastic Type 55 Nitinol.
